(19) United States
(12) Patent Application Publication
(10) Pub. No.: US 2010/0278047 A1
(43) Pub. Date: Nov. 4, 2010

(54) System and Method for Parameter Estimation with Interference Suppression in a Telecommunications Network

(76) Inventors: Havish Koorapaty, Saratoga, CA (US); Jiann-Ching Guey, Fremont, CA (US)

Correspondence Address: ERICSSON INC., 6300 LEGACY DRIVE, M/S EVR 1-C-11, PLANO, TX, 75024, US

(21) Appl. No.: 12/698,798

(22) Filed: Feb. 2, 2010

Related U.S. Application Data
(60) Provisional application No. 61/175,278, filed on May 4, 2009.

(51) Int. Cl. H04W 24/00; H04B 15/00

(52) U.S. Cl. 370/241; 455/63.1

(57) ABSTRACT

A system, method and node of implementing interference suppression for estimation of a signal parameter of a base station transmission at a User Equipment (UE) in a telecommunications network with irregular reference signal patterns assigned to base stations. A list of base stations for which a parameter of the transmitted signal is to be estimated and a list of OFDM symbols and subcarriers to avoid for each base station are compiled. The compiled list is sent to the UE, which performs measurements for each base station using the received measurement information and simple interference avoidance is performed utilizing OFDM symbols and subcarriers not on the list of OFDM symbols and subcarriers to avoid. The measurements are then sent to the network.

### CROSS-REFERENCE TO RELATED APPLICATIONS

This application claims the benefit of U.S. Provisional Application No. 61/175,278, filed May 4, 2009, the disclosure of which is incorporated herein by reference.

### STATEMENT REGARDING FEDERALLY SPONSORED RESEARCH OR DEVELOPMENT:

Not Applicable

### REFERENCE TO SEQUENCE LISTING, A TABLE, OR A COMPUTER PROGRAM LISTING COMPACT DISC APPENDIX:

Not Applicable

### BACKGROUND

The present invention relates to communications networks. More particularly, and not by way of limitation, the present invention is directed to a system and method implementing interference suppression for channel parameter estimation utilizing irregular reference signal patterns in a telecommunications network. One of the channel parameters that may be estimated is the delay of the first path of a multipath channel. The estimation of this parameter enables the determination of the time of arrival of the received signal. Estimation of the time of arrival of the signal is key to the estimation of the position of mobile stations in a wireless communication system which has become an important component of the services provided by a wireless operator. In the United States, operators are required to provide positions of mobile users when the user makes an emergency call. Requirements on the accuracy of position estimates are quite stringent. For solutions that are based in the mobile station, 67% of all positions must have accuracy better than 50 meters while 95% of all positions must have accuracy better than 150 meters.

These requirements, as well as the heightened interest in commercial location based services, has made the provision of a mechanism to compute the position of the mobile station an important part of a wireless communication standard. The Evolved Universal Terrestrial Radio Access standard (E-UTRA) is a standard being developed by the third generation partnership project (3GPP). It is also known as long term evolution (LTE) and provides very high peak data rates and spectral efficiency. Part of the work being done in the development of this standard relates to the estimation of a position of a mobile station.

FIG. 1 illustrates a simplified, high-level block diagram of an Evolved UMTS Terrestrial Radio Access Network (E-UTRAN) or, Long Term Evolution (LTE) architecture E-UTRAN comprises a set of eNBs connected to the Evolved Packet Core (EPC) through the S1 interface. The eNBs are interconnected through the X2 interface. E-UTRAN is layered into a Radio Network Layer (RNL, not shown) and a transport Network Layer (TNL, not shown). E-UTRAN logical nodes and interfaces are defined as part of the RNL and the TNL provides services for user plane transport and a signaling transport.

The LTE standard is based on orthogonal division frequency multiplexing (OFDM) in the downlink. In the development of positioning solutions for LTE, methods based on an estimation of the time of arrival (TOA) of a signal transmitted by a base station (e.g., eNodeB 108) at a mobile station are being considered. Oftentimes, the terms base station and cell may be interchangeably used to denote a single sector in a site that may have many sectors. For example, a single eNodeB 108 may have three sectors spanning an angle of 120 degrees each. TOA estimation based methods are widely considered to be the most robust and accurate among the many different options for position estimation using a terrestrial wireless communication system. The most popular method overall is TOA estimation based positioning using global positioning system (GPS) satellites. The TOA estimates from various cell sites are combined with knowledge of the positions of the eNodeB sites, to compute the unknown position of the mobile station. The fact that the difference between the TOA of a signal at the UE 110 and time of its transmission by the eNodeB 108 is related to the distance between the two nodes is used in the computation of the position from the TOA measurements.

Position computation as discussed above requires the estimation of the TOA from at least three cell sites in geographically different locations. A problem that often arises when measuring the TOA at a UE is that the signal-to-interference ratio (SINR) for some of the sites used to compute the UE's position is very poor. Cellular systems are typically designed to optimize the SINR to the serving cell, but not to the neighboring cell sites. This problem presents a significant challenge in the design of a positioning solution for LTE as well.

One of the solutions that may be used to increase SINR to neighboring cell sites is to increase the reuse of time and frequency resources so that different base stations use orthogonal resources as far as possible. In order to do this, one of the solutions that is being considered in the standardization of LTE is the definition of low-interference subframes (LIS). The LIS are designed to only carry reference signals that may be used for making TOA measurements, but no user data. Ideally, the LIS is aligned across the system, i.e., all cells in the system transmit their low-interference subframes at the same time. The performance of the system is then determined by the design of the reference signals being carried in these subframes.

The reference signals generally occupy resource elements (RE) in the time frequency plane. In LTE, the time frequency plane is split up into units called resource blocks (RB) where each resource block consists of 14 OFDM symbols and 12 subcarriers. A number of resource blocks stacked in the frequency dimension form a subframe with the number of blocks dependent on the bandwidth of the signal. It is desirable for the design of the reference signals to be the same across resource blocks in frequency for ease of implementation at the eNodeB and the UE.

FIG. 2 is a block diagram illustrating resource elements 200 using reference signals based on a regular pattern. The resource elements occupied by example reference signal patterns are shown in a resource block. The pattern uses elements that are placed diagonally in the resource block. A number of reference signals A, B, and C are created by cyclically shifting the resource elements in frequency to generate additional patterns. Reference signals A are used in resource elements 202. Furthermore, when two cells use substantially the same resource elements, as is the case when reference signals B and C, they are differentiated by using different modulation sequences for the reference elements.

The mixed reference signals B and C are depicted at 204 in FIG. 1. In the example shown in FIG. 1, these sequences effectively achieve a reuse factor of 12. Specifically, there are 12 sets of resource elements that are mutually exclusive. Therefore, a set of sequences using one set of resource elements is orthogonal to a set of sequences using a set of different resource elements. This approach increases reuse and improves the SINR to neighboring cell sites. The design illustrated in FIG. 2 is considered as being based on a regular pattern.

FIG. 3 is a block diagram illustrating resource elements 200 using reference signals based on an irregular pattern. An alternate approach to the design of reference signals is to use irregular patterns of resource elements. An example of such a design is shown in FIG. 3. In this example, the resource elements are chosen using a Costas sequence and such an array of resource elements is referred to as a Costas array. In this approach, different cells use sets of resource elements that are generated by applying cyclic frequency and time shifts of the pattern in the resource block. A property of the Costas array is that two patterns with such shifts of each other have symbols that overlap minimally with each other. For example, the pattern shown in FIG. 3 overlap with time frequency shifts of itself in no more than one resource element 210. As depicted in FIG. 3, reference signals B are shown residing in resource element 212 and reference signals C are shown residing in resource elements 214. FIG. 3 shows resource elements where the signals overlap in mixed shading. A large number of resource element patterns may be generated using such time and frequency shifts with different patterns being assigned to different cells. Using only time or frequency shifts generates patterns that are orthogonal to each other. However, using both time and frequency shifts results in some overlapping resource elements.

The use of the approach based on irregular patterns has an advantage in terms of not requiring the use of any careful planning in the assignment of sequences to cells. However, depending on the parameters of the resource block dimensions, it may result in poorer SINR to neighboring cell sites. With both approaches, SINR may be improved with interference suppression at the UE. Specifically, some of the interfering signals are suppressed using signal processing at the UE.

The existing solutions for suppressing interference require the estimation of the parameters of the channel between the interfering eNodeB and the UE before suppressing or cancelling the interference. Other sub-optimal solutions with lower complexity may be used, but typically result in large performance degradation and/or a high degree of complexity. Thus, existing solutions do not sufficiently address the problems discussed above.

### SUMMARY

The present invention provides a novel interference suppression scheme that may be used with irregular reference signal patterns. Due to the small number of overlapping resource elements, two patterns being used by different cell sites interfere only in a few of the OFDM symbols of the resource blocks while they are orthogonal along the remaining OFDM symbols. This property is used to avoid OFDM symbols that exhibit the maximum interference while using the other resource elements to determine the time of arrival measurement.

In one aspect, the present invention is directed at a method of implementing interference suppression for estimating a parameter of a signal transmitted by a base station in a telecommunications network. The method assigns irregular reference signal patterns to a plurality of base stations. From these base stations, a list is compiled of base stations for which a parameter of the transmitted signal is to be estimated and of OFDM symbols and subcarriers to avoid for each of the base stations that is to be measured. The compiled list is sent as measurement information to a User Equipment. The UE receives the information and performs measurements for each base station in the compiled list based on the received measurement information. Simple interference avoidance is performed by utilizing OFDM symbols and subcarriers that are not on the list of symbols and subcarriers to avoid and the measurements are sent to the network.

In another aspect, the present invention is directed at a system for implementing interference suppression to estimate a parameter of a signal transmitted by a base station in a telecommunications network. Irregular reference signal patterns are assigned to a plurality of base stations. A UE requests information for estimating a parameter of the signal and a node in the network compiles a list of base stations that will have a parameter of its transmitted signal estimated. A list of OFDM symbols and subcarriers to avoid for each base station to be measured is provided and the node sends the compiled list to the UE. The UE performs measurements for each base station on the compiled list and simple interference avoidance is performed by utilizing OFDM symbols and subcarriers that are not on the avoidance list provided. The measurements are then sent to the network.

In a further aspect, the present invention is directed at a User Equipment (UE) implementing interference suppression for estimating a parameter of a signal transmitted by a base station in a telecommunications network. The UE requests information for estimating the parameter of the signal and receives a compiled list of base stations to measure and a list of OFDM and subcarriers to avoid for each base station to be measured. The UE performs the measurements using simple interference avoidance by using OFDM symbols and subcarriers that are not on the avoidance list provided. The measurements are then sent to the network.

In still another aspect, the present invention is directed at a node for implementing interference suppression for estimating a parameter of a signal transmitted by a base station in a telecommunications network. The node assigns irregular reference signal patterns to base stations and from those base stations a list is complied for determining an estimate of the parameter of the signal. Then a list of Orthogonal Division Frequency Multiplexing symbols and subcarriers to avoid for each base station is compiled and sent to the UE.

### BRIEF DESCRIPTION OF THE DRAWINGS

In the following section, the invention will be described with reference to exemplary embodiments illustrated in the figures, in which:

FIG. 1 (Prior Art) illustrates a simplified, high-level block diagram of an Evolved UMTS Radio Access Network (E-UTRAN) or, Long Term Evolution (LTE) architecture;

FIG. 2 (Prior Art) is a block diagram illustrating resource elements using reference signals based on a regular pattern;

FIG. 3 (Prior Art) is a block diagram illustrating resource elements using reference signals based on an irregular pattern;

FIG. 4 illustration the correlation operation where a symbol in the correlation operation may be set to zero in a first embodiment of the present invention;

FIG. 5 is a flow chart illustrating the steps of sending assistance data to the UE;

FIG. 6 is a flow chart illustrating the steps of making measurements using assistance data from the telecommunications network;

FIG. 7 illustrates the correlation as a sum of partial correlations where one or more correlations are set to zero in a second embodiment of the present invention; and

FIGS. 8A and 8B are flowcharts illustrating the steps performed at the UE for suppressing interference with irregular patterns.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

The present invention is a suppression scheme for use when reference signals based on irregular patterns are utilized. Due to the small number of overlapping resource elements, two patterns being used by different cell sites interfere only in a few of the OFDM symbols of the resource blocks while the remaining OFDM symbols are orthogonal. This property is used to avoid the OFDM symbols that exhibit the maximum interference while using the other resource elements to determine time of arrival measurements. The present invention provides various embodiments for the determination of the OFDM symbols to avoid.

In one embodiment, let sₘ[n,k], wherein n={1,2, . . . , N},k={1, 2, . . . , K}, represent the sampled version of the transmitted reference signal in OFDM symbol n and subcarrier k, where N is the number of OFDM symbols used to transmit the reference signal and K is the number of subcarriers in an OFDM symbol. Then, the received signal from the M^{th} cell may be represented by:

r[n,k^{p}_{D}(n)]=c_{D}[n,k^{p}_{D}(n)]·s_{D}[n,k^{p}_{D}(n)]+c_{I}[n,k^{p}_{D}(n)]·sᵢ[n,k^{p}_{D}(n)]+z[n,k^{p}_{D}(n)],n={1,2, . . . , N}

where kP_{D}(n) is the subcarrier occupied by the pth reference symbol in OFDM symbol n for the desired reference signal, s_{I}[n, k^{p}_{D}(n)] is the interfering symbol in the subcarrier occupied by the pth symbol in OFDM symbol n for the desired reference signal, c_{D}[n,k⁹_{D}(n)] and c_{I}[n, kP_{D}(n)] are the channels for the desired and interfering signals and z[n, k^{p}(n)] is the noise in the associated subcarrier.

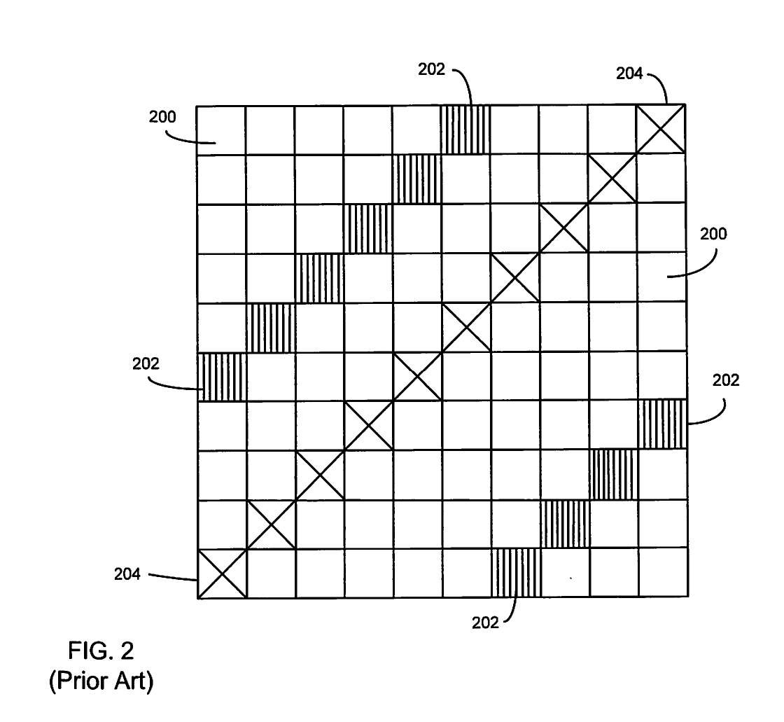

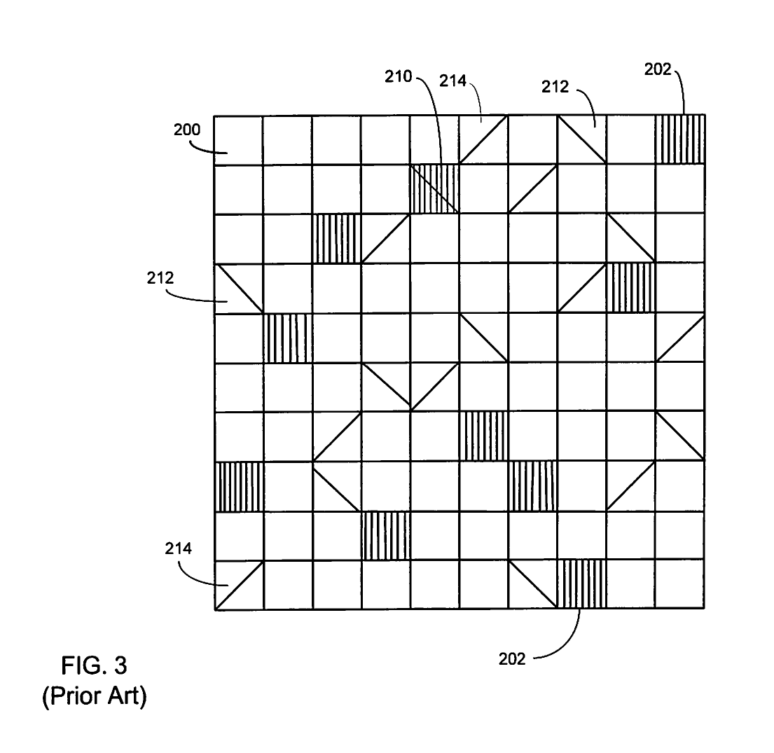

In the scenario where the approach with regular patterns with a standard reuse is used as discussed in FIG. 2, the subcarriers used by the desired and interfering signals are either completely orthogonal or completely coincide. That is, k⁹_{D}(n)=k^{P}_{I}(n) for a substantial number of p and n when the signals are not orthogonal. When the second approach with irregular patterns is used, k^{p}_{D}(n)=k^{p}_{I}(n) for a very small fraction of the subcarriers p and symbols N.

The most common method to measure time of arrival is through the use of a correlator whose output may be described as follows:

b[t]=Σₜs*[q]·r[q+t],t={−T,−T+1, . . . , T},

where 2T is the TOA time uncertainty window. The time of arrival is then estimated as the peak of the function |b[t]|². The signal s[q] is then defined purely in time, with q={1, 2, . . . , NK} where N is the number of OFDM symbols and K is the number of samples per symbol. In the first embodiment, only the subcarriers p and the OFDM symbols n for which k^{p}_{D}(n) ≠k^{p}_{I}(n) are utilized to perform time of arrival estimation. This may be achieved by modifying the signal s[q] prior to performing the correlation operation as discussed above. For example, if some OFDM symbols are not to be used, this may be achieved by simply setting the corresponding parts of the signal s[q] to zero. Specifically, if symbol v is to be avoided, s[q]=0 for q={(v-1)K+1, (v-1)K+2, . . . , vK}.

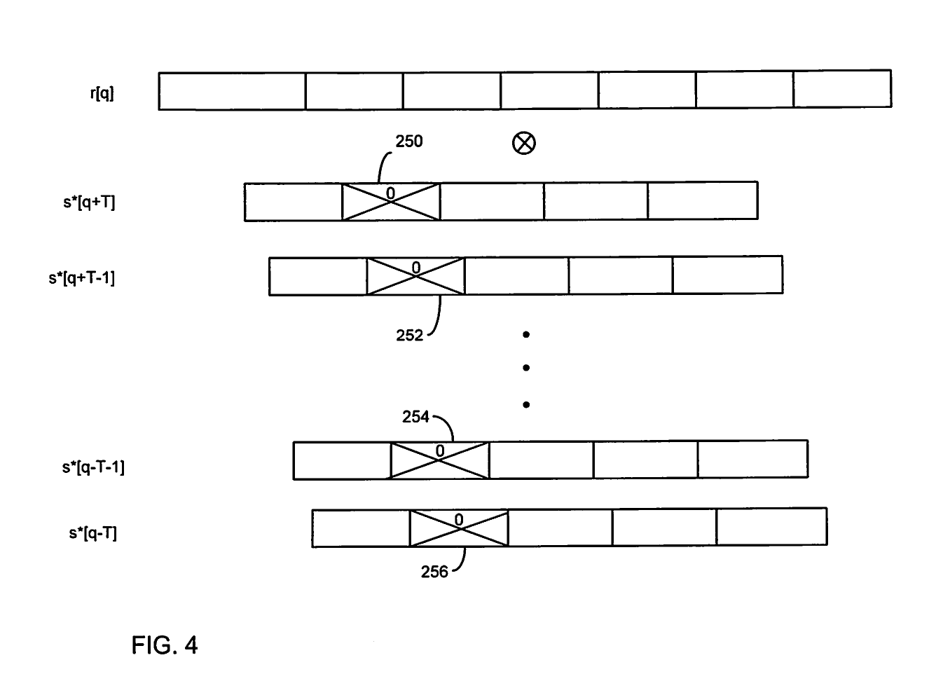

FIG. 4 illustrates the correlation operation where a symbol in the correlation operation may be set to zero in a first embodiment of the present invention. OFDM symbols at 250, 252, 254, and 256 are set to zero. The lack of use of some symbols and subcarriers reduces the received power from the desired signal in the subcarriers and symbols where the interfering signal overlaps with the desired signal. However, this also suppresses the interference in these subcarriers and symbols. In interference limited environments, the net effect is a large increase in the signal-to-interference and noise ratio (SINR). Ideally, it would be advantageous to estimate the interfering symbols and channel along the subcarriers and symbols where the desired and interfering signals overlap and then cancel the interference. However, in the present invention, it is an objective to achieve most of the gain realizable with an optimal solution but using a sub-optimal solution having lower complexity.

The choice of which symbols and subcarriers to use and which to leave out may be made in several ways. In one embodiment, this information is provided to the UE by the eNodeB or some other node in the cellular network. The telecommunications network is aware of the reference signals patterns that have been assigned to all the neighboring sites and may use this information to compute which symbols and subcarriers should be avoided. Information on which reference signals to use for measurements is typically provided as assistance data to the UE when measurements for position estimation are to be made. This information is supplemented with the information on which subcarriers and symbols should not be used when measuring the TOA of each reference signal.

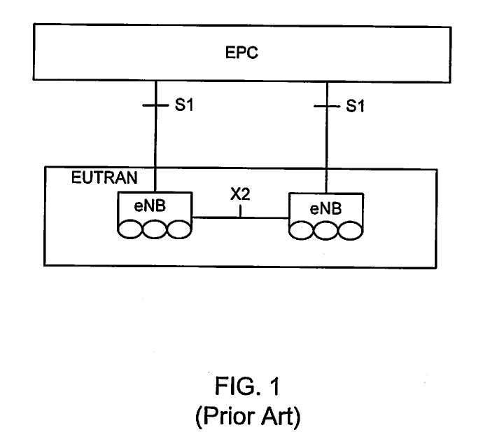

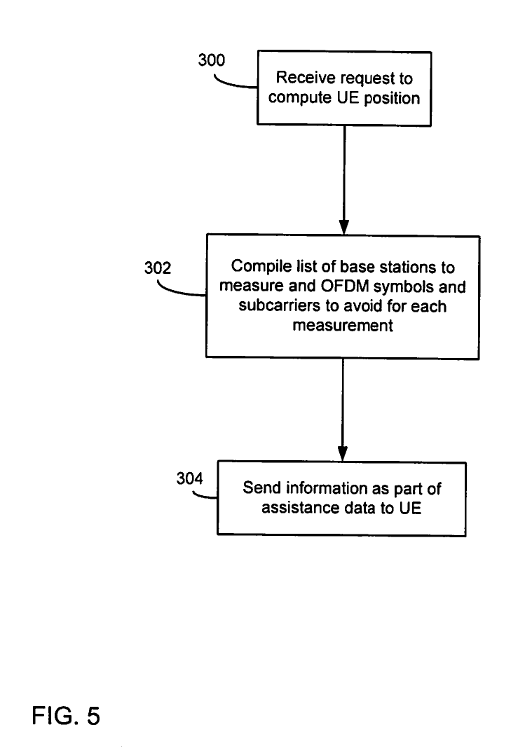

FIG. 5 is a flow chart illustrating the steps of sending assistance data to the UE 110 in accordance with an embodiment of the invention. With reference to FIGS. 1, 4, and 5, the method will now be explained. In step 300, the base station (e.g., eNodeB 108) receives a request to compute UE 110's position. The request may be from the UE 110 or any other source. Next, in step 302, a list of base stations to measure and OFDM symbols and subcarriers to avoid for each measurement is compiled as measurement information by the telecommunications network. In step 304, the measurement information is sent as a portion of the assistance data to the UE.

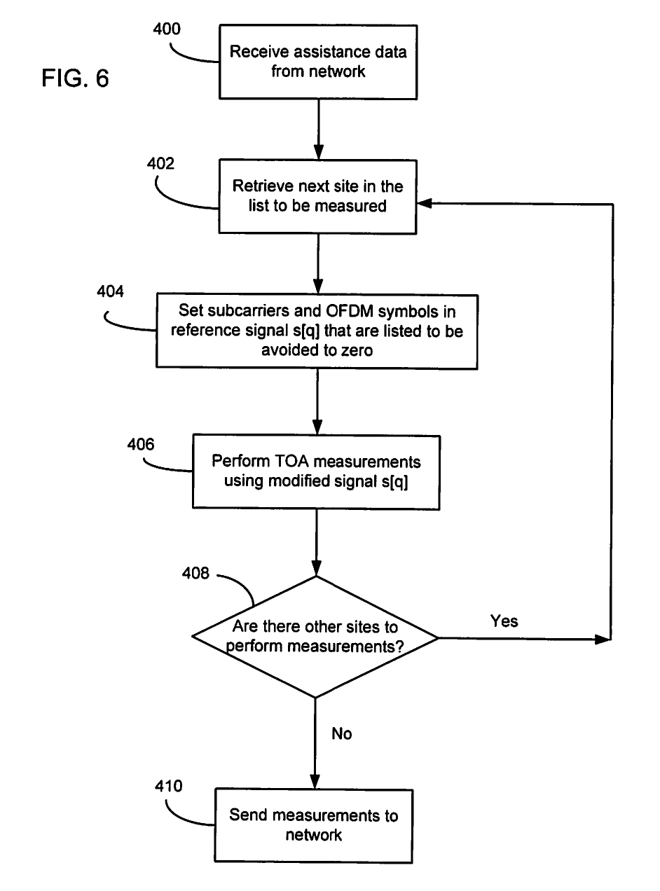

FIG. 6 is a flow chart illustrating the steps of making measurements using assistance data from the telecommunications network in accordance with an embodiment of the invention. With reference to FIGS. 1, 4, 5, and 6, the method will now be explained. In step 400, the UE receives assistance data from the telecommunications network. Next, in step 402, the UE retrieves the next site in a list of base stations to be measured. In step 404, the subcarriers and OFDM symbols in reference signal s[q] that are listed as to be avoided for the specified site are set to zero. Next, in step 406, the UE performs TOA measurements using the modified signal s[q]. In step 408, it is determined if there are more sites to perform TOA measurements. If it is determined that there is another site to perform TOA measurements, the method moves to step 402 where the UE retrieves the next site to be measured. However, in step 408, if it is determined that there are no more sites to measure, the method moves to step 410 where the measurements obtained in step 406 are sent to the eNodeB 108 or a specified node in the telecommunications network.

In another embodiment of the present invention, the UE determines which symbols to avoid by performing partial correlations with the received signal and leaving out correlation outputs corresponding to the symbols that have the maximum energy. The symbols having the maximum energy are most likely to have interference in addition to the desired symbols. This signal can be split up as the sum of a number of individual parts with each part spanning one OFDM symbol period. Thus:

s[q]=s₁[q]+s₂[q]+ . . . +s_{N[q], where}

sᵢ[q]=0 everywhere except when q={(i-1)·K+1, (i-1)·K+2, . . . , (i-1).K+K}, i={1, 2, . . . , N}

The correlator output above can then be expressed as:

b[t]=Σᵢ(Σₜsᵢ*[q]·r[q+t])=Σᵢbᵢ[t],t={−T,−T+1, . . . , T},i={1,2, . . . , N}

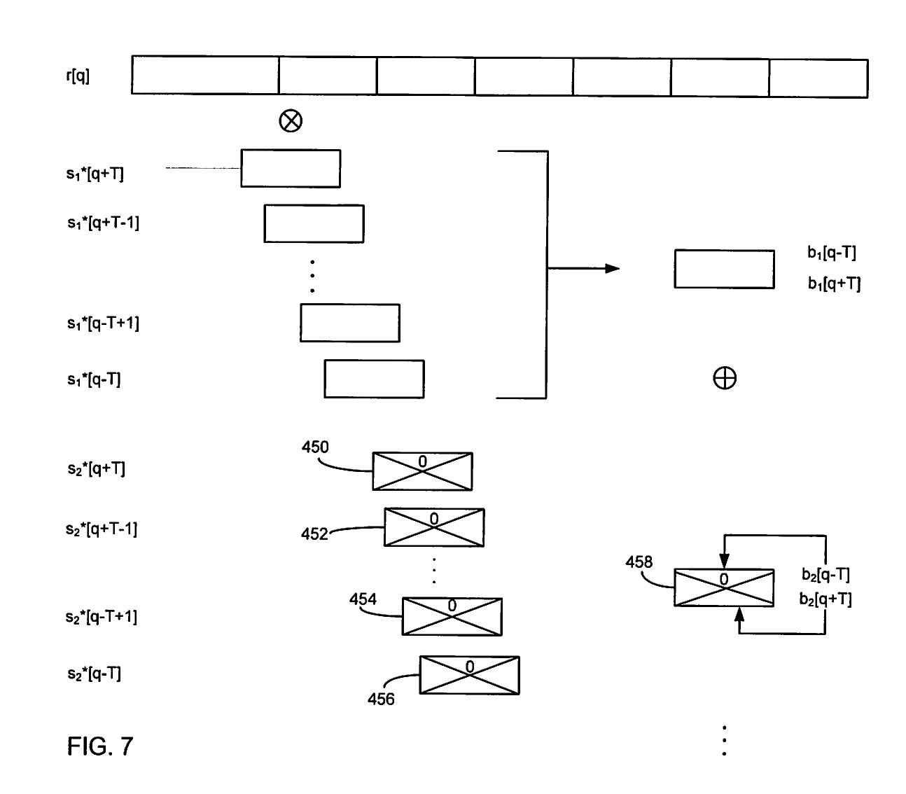

In another embodiment of the present invention, N correlator outputs bᵢ[t]=Σₜ sᵢ[q+t]·r[q], i=1, 2, . . . , N are formed with the number of operations in each significantly reduced since most of the signal, except for one OFDM symbol, is spanned by zeros. Subsequently, the maximum energy in each of the correlators, bᵢ[t], is measured and the U symbols with the highest correlator energy are not used in measuring the TOA where U is an adjustable parameter. This is achieved by setting bᵢ[q]=0, when the i^{th} symbol is one of the U symbols corresponding to the highest correlator energy, before summing the correlator outputs to obtain b[t]. FIG. 7 illustrates the correlation as a sum of partial correlations where one or more correlations are set to zero in a second embodiment of the present invention. As depicted in FIG. 7, the present invention effectively avoids the interference that overlaps with resource elements of the desired signal in the symbols that have not been used for correlation. Correlations at 450, 452, 454, 456, and 458 are all set to zero.

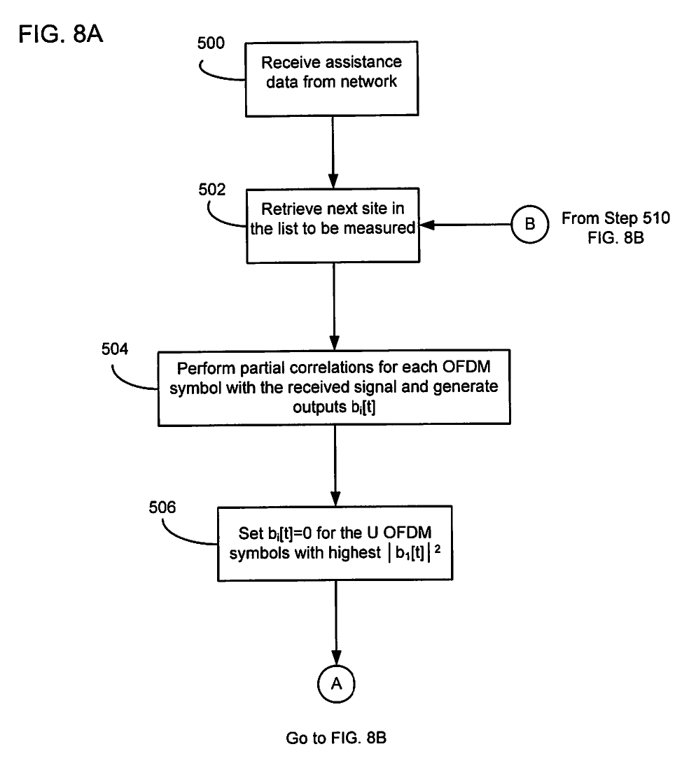

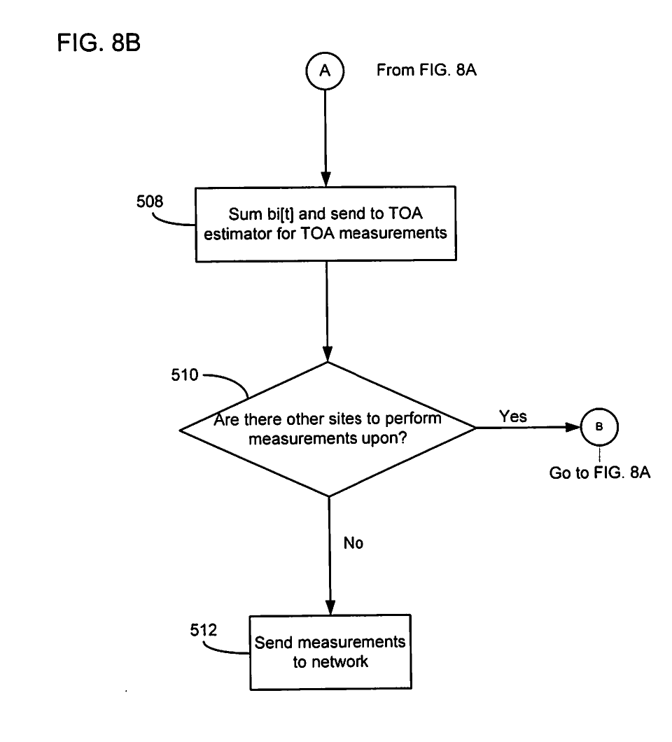

FIGS. 8A and 8B are flowcharts illustrating the steps performed at the UE 110 for suppressing interference with irregular patterns. With reference to FIGS. 1, 5, 7, and 8, the Page 10 of 18 steps of the method will now be explained. In step 500, the UE 110 receives assistance data from the network (e.g., eNodeB 108). Next, in step 502, the UE retrieves the next site in a list of base stations to be measured. In step 504, partial correlations are performed for each OFDM symbol with the received signal and outputs b₁[t] are generated. Next, in step 506, b₁[t] is set to zero for the U OFDM symbols with the highest |b₁[t]|². In step 508, b₁[t] is summed and sent to the TOA estimator in the UE where the TOA measurements are conducted. Next, in step 510, it is determined if there are more sites to perform TOA measurements. If it is determined that there is another site to perform TOA measurements, the method moves to step 502 where the UE retrieves the next site to be measured. However, in step 510, if it is determined that there are no more sites to measure, the method moves to step 512 where the measurements obtained in step 508 are sent to eNodeB 108 or a specified node in the telecommunications network.

The present invention utilizes the suppression of interference for making TOA measurements by avoiding certain OFDM symbols and subcarriers. Two embodiments have been discussed for determining which symbols and subcarriers should be avoided. However, in the present invention, any variation of the methodology discussed above may be used to determine specific OFDM symbols and/or subcarriers to avoid in order to suppress interference.

In another embodiment of the present invention, the UE selects fewer symbols to perform correlations with when operating in interference limited environment while selecting more or all symbols when operating in a noise limited environment. When cell sizes are small, the impairment tends to be dominated by signals from other cells. In such a scenario, the UE may avoid some symbols and correlate with fewer symbols to achieve interference suppression and boost SINR. When cell sizes are large, the impairment tends to be dominated by white noise. In this case, the UE may utilize all the symbols since this provides gain against noise.

The present invention provides many advantages over existing telecommunications systems. The complexity of the interference suppression scheme associated with irregular patterns with minimal overlapping information elements is quite low compared to interference suppression when a substantial number of the resource elements of the desired and interfering signals overlap. In addition, the use of irregular patterns with minimal overlaps as reference signals transmitted from cells in conjunction with the low-complexity interference suppression scheme provides an improvement in the SINR at the UE and consequently in position estimation accuracy.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

1. A method of estimating a parameter of a signal transmitted by a base station in a telecommunications network, the method comprising the steps of:
assigning irregular reference signal patterns to a plurality of base stations;
compiling a list of base stations from the plurality of base stations for which a parameter of the transmitted signal is to be estimated;
determining a list of Orthogonal Division Frequency Multiplexing (OFDM) symbols and subcarriers to avoid for each base station to be measured;
performing measurements for each base station of the compiled list based on the received measurement information, wherein simple interference avoidance is performed by utilizing OFDM symbols and subcarriers not on the list of OFDM symbols and subcarriers to avoid.

2. The method according to claim 1 further comprising the network sending the compiled list of base stations to measure and list of OFDM symbols and subcarriers to avoid, as measurement information.

3. The method according to claim 1 further comprising sending the measured signal parameters to the telecommunications network for further processing.

4. The method according to claim 1, wherein the irregular reference signal patterns intersect minimally with the irregular reference signal patterns from other base stations.

5. The method according to claim 1, wherein a TOA measurement is used to estimate a position of the UE.

6. The method according to claim 1, wherein the step of performing measurements includes:
modifying a signal s[q] by setting to zero the parts of the signal corresponding to subcarriers and OFDM symbols that are to be avoided; and
performing measurements using the modified signal s[q].

7. The method according to claim 5, wherein the step of performing TOA measurements includes performing partial correlations for each OFDM symbol within the received signal.

8. The method according to claim 7, wherein the step of performing partial correlations includes generating outputs bᵢ[t] from the partial correlations and setting bᵢ[t] to zero for OFDM symbols having a specified high energy output.

9. The method according to claim 1, wherein the parameter of the signal estimated is one or more of; the received power of the signal, Time of Arrival, received signal strength and a complex channel estimate.

10. A system for estimating a parameter of a signal transmitted by a base station in a telecommunications network, the system comprising:
a UE requesting information for estimating the parameter of the signal;
network means for assigning irregular reference signal patterns to a plurality of base stations;
a node for compiling a list of base stations from the plurality of base stations for which a parameter of the transmitted signal is to be estimated; and
means in the node for determining a list of Orthogonal Division Frequency Multiplexing (OFDM) symbols and subcarriers to avoid for each base station to be measured; and
means for performing measurements for each base station of the compiled list based on the received measurement information, wherein simple interference avoidance is performed by utilizing OFDM symbols and subcarriers not on the list of OFDM symbols and subcarriers to avoid.

11. The system of claim 10 further comprising transmitting means for sending the compiled list of base stations to measure and a list of OFDM symbols and subcarriers to avoid as measurement information to the UE.

12. The system of claim 10, further comprising means for sending the measurement information to the telecommunications network.

13. The system according to claim 10, wherein the irregular reference signal patterns intersect minimally with the irregular reference signal patterns from other base stations.

14. The system according to claim 10, wherein a TOA measurement is used to estimate a position of the UE.

15. The system according to claim 10, wherein the means for performing measurements includes:
means for modifying a signal s[q] by setting the parts of the signal corresponding to subcarriers and OFDM symbols to zero that are to be avoided; and
means for performing measurements using the modified signal s[q].

16. The system according to claim 10, wherein the means for sending the measurements to the telecommunications network includes means for sending the measurements to an eNodeB.

17. The system according to claim 14, wherein the means for performing time of arrival measurements includes means for performing partial correlations for each OFDM symbol within the received signal.

18. The system according to claim 17, wherein the means for performing partial correlations includes means for generating outputs bᵢ[t] from the partial correlations and setting bᵢ[t] to zero for OFDM symbols having a specified high energy output.

19. The system according to claim 10, wherein the parameter of the signal estimated is one or more of; the received power of the signal, Time of Arrival, received signal strength and a complex channel estimate.

20. A node for providing assistance information for estimating a parameter of a signal transmitted by a base station in a telecommunications network, the node comprising:
means for assigning irregular reference signal patterns to a plurality of base stations;
means for compiling a list of base stations from the plurality of base stations to measure for determining an estimate of the parameter of the signal;
means for determining a list of Orthogonal Division Frequency Multiplexing, OFDM, symbols and subcarriers to avoid for each base station to be measured; and
means for sending the compiled list of base stations to measure and list of OFDM symbols and subcarriers to avoid as measurement information to the UE.

21. The node according to claim 20, wherein the irregular reference signal patterns intersect minimally with patterns from each of the plurality of base stations.

22. The node according to claim 20, wherein the parameter of the signal is a Time of Arrival (TOA) measurement, which is used to estimate a position of the UE.

23. The node according to claim 20, wherein the parameter of the signal estimated is one or more of the Time of Arrival, received signal strength and a complex channel estimate.

24. A User Equipment (UE) for estimating a parameter of a signal transmitted by a base station in a telecommunications network, the UE comprising:
means for making measurements wherein simple interference avoidance is performed by utilizing only some of the OFDM symbols and subcarriers.

25. The UE of claim 24, further comprising means for receiving information comprising a complied list of base stations to measure and a list of Orthogonal Division Frequency Multiplexing (OFDM) symbols and subcarriers to avoid for each base station to be measured.

26. The UE of claim 24, further comprising means for requesting information for estimating the parameter of the signal and means for sending the measurements to the telecommunications network.

27. The UE according to claim 26 wherein the parameter of the signal is one or more of the, Time of Arrival, received signal strength and a complex channel estimate.

28. The UE according to claim 24 wherein the means for performing measurements includes:
means for modifying a signal s[q] by setting to zero the parts of the signal corresponding to subcarriers and OFDM symbols that are to be avoided; and
means for performing measurements using the modified signal s[q].

29. The UE according to claim 25 wherein a means for performing time of arrival measurements includes means for performing partial correlations for each OFDM symbol within the received signal and
means for generating outputs bᵢ[t] from the partial correlations.

30. The UE according to claim 28 wherein the means for generating outputs bᵢ[t] includes setting bᵢ[t] to zero for OFDM symbols having a specified high energy output.
